(19) United States
(12) Patent Application Publication
(10) Pub. No.: US 2004/0009816 A1
(43) Pub. Date: Jan. 15, 2004

(54) Game for play in conjunction with a competition

(75) Inventor: David Samuel Miller, Victoria (AU)

Correspondence Address: James G. Coplit, Esq., GRIMES & BATTERSBY, LLP, Third Floor, 488 Main Avenue, Norwalk, CT, 06851, US

(73) Assignee: Zone Properties Pty. Ltd.

(21) Appl. No.: 10/194,789

(22) Filed: Jul. 12, 2002

(51) Int. Cl. A63F 13/00

(52) U.S. Cl. 463/42; 700/91

(57) ABSTRACT

A game for a plurality of game players, in conjunction with one or more events whose outcomes are unknown prior to their performance, wherein one or more participants take part in each event, the game comprising: one or more sets of game cards (FIGS. 2-5 and 10), each card being representative of a participant in said one or more events; selection means (45) for selection by each player of one or more participants in each event in advance of the performance of each event, participant selection being based upon the predicted behaviour by the participants during each event, each selected participant corresponding to a game card in possession of that player, storage means (9) for centrally storing participant selection information indicative of the one or more participants selected by each player, and assessment means (67) for assessing the actual behaviour of each participant during the actual performance of the event against stored participant selection information of each player to thereby determine one or more winning players.

The present invention relates generally to games of skill and chance which are designed for play in conjunction with one or more events with outcomes unknown prior to their performance, such as football matches. In particular, the present invention relates to a game in which game cards are purchased by players of the game to predict the behaviour of participants during each event. The present invention is suitable for use in conjunction with football matches played during a football competition, and it will be convenient to describe the invention in relation to that exemplary application. It is to be appreciated, however, that the invention is not limited to that application.

The popularity of professional sports has increased dramatically with extensive television and media coverage of professional sporting events. Sports enthusiasts are able to obtain regular information as to the progress of their favourite team in a competition, as well as assessing the likelihood of success of their team in upcoming matches during the competition. Prior to each round of the competition, sports enthusiasts closely follow the likely composition of their favourite team, the fitness of the players in the team, and various other factors likely to influence the performance of their team.

The interest of sports enthusiasts also extends beyond the simple performance of their team to other factors, such as the private lives of the players involved, the manner in which their favourite club is managed, developments within the competition as a whole, etc. Increasing sales of promotional products associated with sporting teams illustrate the sports enthusiast's desire to emotionally participate in the activities of their favourite team, rather than to simply observe the performance of that team on the playing field.

There currently exists a need to provide a means of more fully involving the sports enthusiasts in the activities of their favourite sports team.

There also exists a need to provide merchandising products of interest to sports enthusiasts which adds to their sense of participation in their team's activities.

With this in mind, one aspect of the present invention provides a game for a plurality of game players, in conjunction with one or more events whose outcomes are unknown prior their performance, wherein one or more participants take part in each event, the game comprising:

one or more sets of game cards, each card being representative of a participant in said one or more events;

selection means for selection by each player of one or more participants in each event in advance of the performance of each event, participant selection being based upon the predicted behaviour by the participants during each event, each selected participant corresponding to a game card in possession of that player;

storage means for centrally storing participant selection information indicative of the one or more participants selected by each player, and assessment means for assessing the actual behaviour of each participant during the actual performance of the event against stored participant selection information of each player to thereby determine one or more winning players.

In one embodiment, each event may be a sporting contest. One or more such events may form at least part of a competition including a series of one or more of such sporting contests. Each sporting contest may be played between two or more teams of a plurality of participants, such as a football match.

It will be appreciated that in the context of the present invention, the game cards may include both real cards sold through conventional retail outlets and/or virtual cards that may be purchased on-line and are visible by means of a computer display.

The behaviour of each participant during the event may correspond to the completion by each participant of predefined activities during that event. Each of the participants may be awarded a predetermined number of points for the completion of each of the predetermined activities. For example, during a football match, a predetermined number of points may be awarded for each kick, tackle, goal and like activity completed by each participant. The assessment means may act to assess the performance of each participant by total number of points awarded to that participant during each event.

Each of the participants may be categorised according to one of a plurality of categories, the participant selection information being indicative of one or more participants from each of the plurality of categories. Each of these categories may correspond to a role played by one or more of the participants during each event. For example, during a football match, the plurality of categories may include back men, mid fielders, forwards and ruck men. Players of the game may select one or more participants from each of these categories prior to the performance of each event.

In one embodiment, each participant may be eligible to participate in a plurality of events during the competition. For example, a competition may comprise a plurality of rounds in which a team of participants compete against other teams in the competition. Each of the game cards may bear information identifying one or more of the plurality of events. Conveniently, the set of game cards may include the plurality of game cards indicative of each participant, each game card bearing information identifying different ones of the plurality of events. In one form of the game, participant selection before each event may be based upon possession by a player of a game card indicative of a participant for that event.

In one embodiment, the game may further comprise verification means for verifying the position by each winning player of game cards indicative of participant selected by that winning player. The verification means may further act to verify that each game card upon which participants are selected corresponds to a particular event.

Another aspect of the present invention provides a method of playing a game, by a plurality of players, in conjunction with one or more events whose outcomes are unknown prior to their performance, wherein one or more participants take part in each event and the game includes a plurality of game cards, each card being indicative of a participant in said one or more events, the method comprising the steps of:

selecting by each player of one or more participants in each event in advance of the performance of each event, participant selection being based upon the predicted behaviour by the participants during each event, each selected participant corresponding to a game card in possession of that player,

centrally storing participant selection information indicative of the one or more participants selected by each player, and

assessing the actual behaviour of each participant during the actual performance of the event against the stored participant selection information of each player to thereby determine one or more winning players.

A further aspect of the invention provides a game for a plurality of players, in conjunction with one or more events whose outcomes are unknown prior to their performance, wherein one or more participants take part in each event, the game comprising:

one or more sets of game cards each indicative of a participant in said one or more events,

a central controller including a processing means and a memory means operatively connected to the processing means, the memory means containing a program, adapted to be executed by the processing means, for

(i). selection by each player of one or more participants in each event in advance of the performance of each event, participant selection being based upon the predicted behaviour by the participants during each event, each selected participant corresponding to a game card in possession of that player,

(ii). centrally storing participant selection information indicative of the one or more participants selected by each player, and

(iii). assessing the actual behaviour of each participant during the actual performance of the event against the stored participant selection information of each player to thereby determine one or more winning players, and

at least one remote terminal, adapted for communication with the central controller, for transmitting the participant selection information to the central controller.

A still further aspect of the present invention provides a game for a plurality of players, in conjunction with one or more events whose outcomes are unknown prior their performance, wherein one or more participants take part in each event, the game comprising:

one or more sets of game cards, each card being representative of a participant in said one or more events;

selection means for selection by a game organiser of a plurality of selected participants in each event in advance of the performance of each event,

assessment means for assessing the actual behaviour of each of said selected participants during the actual performance of the event to thereby determine one or more winning participants, and one or more game winning players being subsequently determined by possession of a game card corresponding to said one or more winning participants.

Yet another aspect of the present invention provides a method of playing a game, by a plurality of players, in conjunction with one or more events whose outcomes are unknown prior to their performance, wherein one or more participants take part in each event and the game includes a plurality of game cards, each card being indicative of a participant in said one or more events, the method comprising the steps of:

selecting by a game organiser of a plurality of selected participants in each event in advance of the performance of each event, and

assessing the actual behaviour of each of said selected participants during the actual performance of the event to thereby determine one or more winning participants, one or more game winning players being subsequently determined by possession of a game card corresponding to said one or more winning participants.

The following description refers in more detail to the various features of the game and method of playing a game of the present invention. To facilitate an understanding of the invention, reference is made in the description to the accompanying drawings where the game and method of playing a game are illustrated in a preferred embodiment. It is to be understood that the present invention is not limited to the preferred embodiment as illustrated in the drawings.

In the drawings:

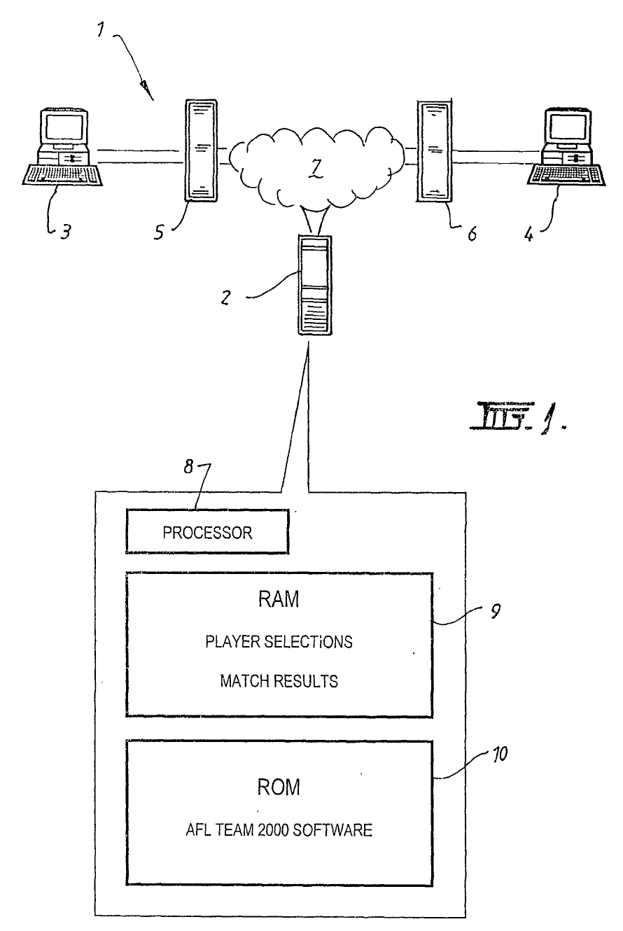

FIG. 1 is a schematic diagram illustrating a central controller and remote terminals for use in the playing of a game in accordance with the present invention;

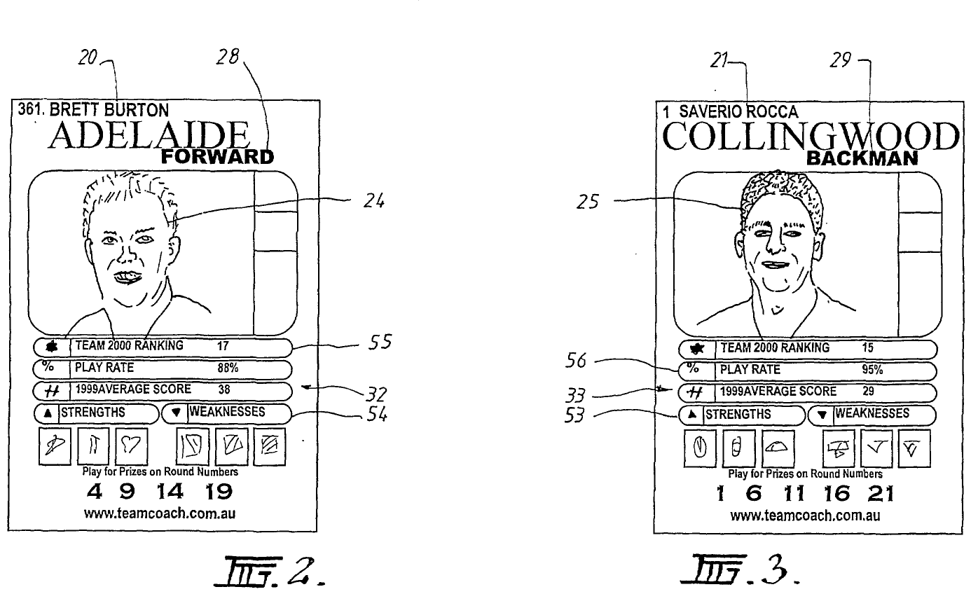

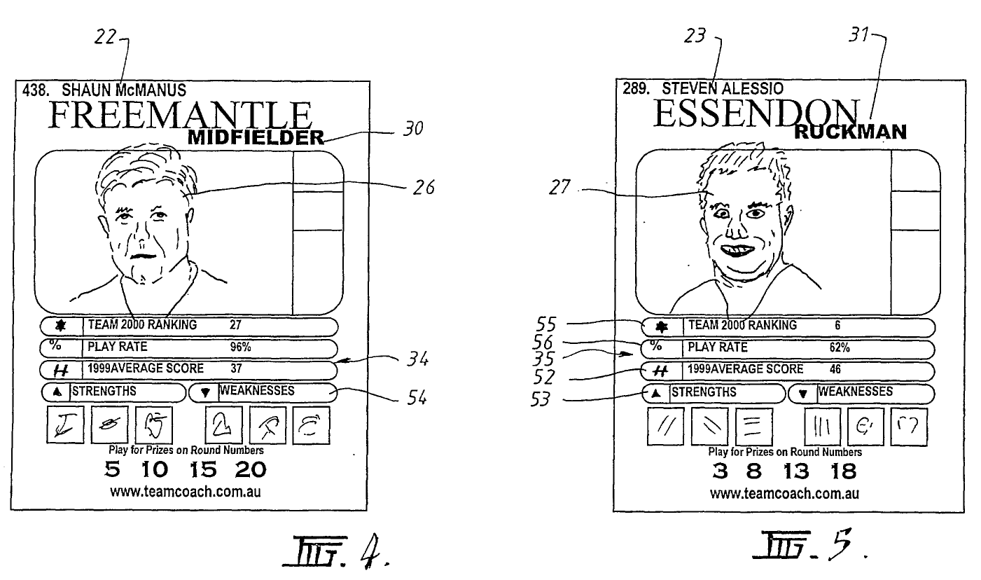

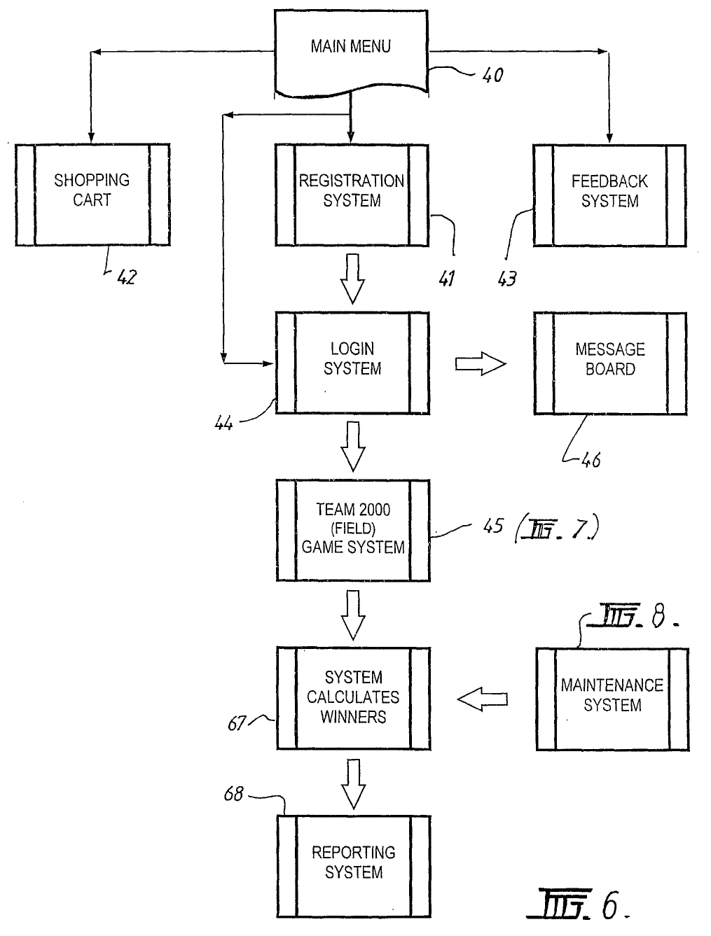

FIGS. 2 to 5 are representations of game cards forming part of one embodiment of the game of the present invention;

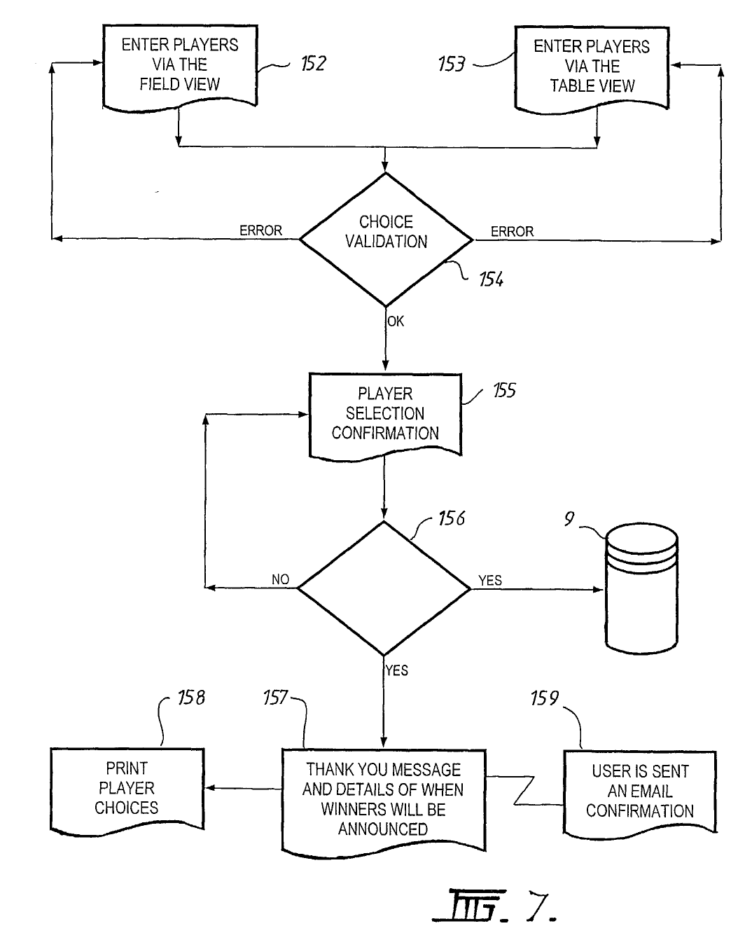

FIGS. 6 to 8 are representative flow charts illustrating the operation of the central controller represented in FIG. 1 in the performance of one embodiment of a game according to the present invention;

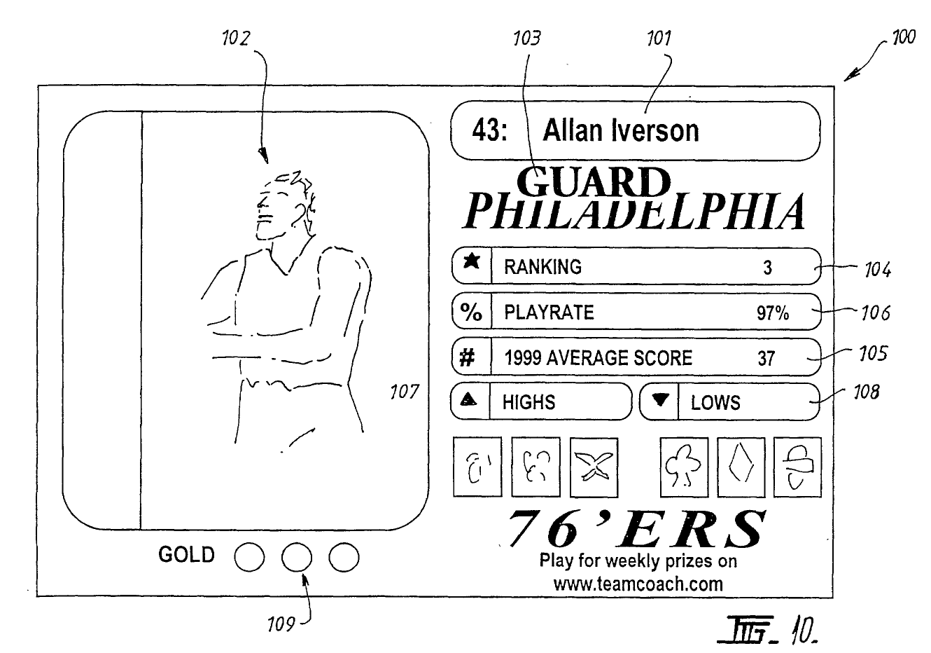

FIG. 9 is a representation of a user interface for use by a participant in one embodiment of the game according to the present invention; and

FIG. 10 is a representation of a game card forming part of a second embodiment of a game according to the present invention.

Referring now to FIG. 1, there is shown generally a telecommunications network 1 including a central controller 2 and remote terminals 3 and 4 adapted for communicating with the central controller 2. Conveniently, the remote terminals 3 and 4 may be connected by Internet service providers 5 and 6 to an Internet backbone network 7. The central controller 2 may also be connected to the Internet backbone network 7. Communications between the Internet service providers 5 and 6 and the central controller 2 take place by the transmission of data packets using the Internet protocol.

Typically, the central controller 2 comprises a processor 8 and memory devices 9 and 10 operatively connected to the processor 8. The memory device 10 is of the non volatile type and is used for the storing of a computer program adapted to be executed by the processor 8 for the performance of predefined tasks by the central controller 2. The memory device 9 is of the volatile type and is used to store data transmitted to the central controller 2 and generated as a result of the operations performed by the central controller 2.

The game of the present invention may be played in conjunction with one or more events whose outcomes are unknown prior to their performance. A series of such events may form part of a competition. Examples of suitable events including sporting contests, and in particular those sporting contests which are played between two or more teams of participants. Sporting contests such as football, baseball, cricket, rugby, basketball, ice hockey and the like are all examples suitable for use with the present invention. It should be appreciated, nevertheless, that the present invention is not limited to use for play in conjunction with sporting events only.

The game according to the present invention will now be described in relation to Australian football. An Australian football match consists of a contest between two teams on a sporting field. The aim of each contest is to score more points than the opposition team by causing an oval shaped ball to pass between goal posts at a given end of the sporting field. If the ball is kicked between two central goal posts without being subsequently touched by any participant in the match, a goal (6 points) is scored. If the ball is passed through the two central goal posts in any other manner, or between two outer goal posts, one point is scored. The ball is advanced on the sporting field between participants of a same team by taking possession of the ball and then either kicking or hand-passing the ball to a team mate. If a ball is kicked to a participant, and then caught by that participant without firstly touching the ground or the body of another participant, a “mark” is given to that participant. A participant from one team may tackle a participant of another team to prevent him from taking possession of the ball. Should this tackle not be carried out in accordance with various rules of the match, a “free kick” or other penalty will be awarded. When a goal is scored by either team, the ball is then returned to the centre of the sporting field and bounced by an umpire. Generally, during a bounce or ball up a participant from one or other of the teams will attempt to direct the football by tapping or punching with his hand towards one of his team mates, this being known as a “hit out”.

The Australian Football League organisers a yearly competition between sixteen teams. Each yearly competition includes a series of twenty two rounds of regular matches, together with finals matches. The participants within each Australian Football League team are categorised according to a role which each of them play during the match. In the present example, participants are classified according to their nominal playing position on the sporting field, as either backmen, midfielders, forwards or ruckmen (the position on the sporting field changes to follow the position of the ball at any time).

The game according to the present invention includes one or more sets of game cards, each of which is representative of an intended participant in one or more of the matches held as part of the Australian Football League competition. In the present example, one hundred leading participants in the Australian Football League competition are selected by the game organisers, and one or more game cards within each set of game cards are printed with appropriate indicia or otherwise marked so as to be representative of each of these one hundred selected participants. Examples of these game cards are shown in FIGS. 2 to 5. As can be seen from these figures, each game card includes the name 20 to 23 and image 24 to 27 of each participant. Each of the game cards shown in FIGS. 2 to 5 also includes the nominal category (backmen, midfielders, forwards or ruckmen) 28 to 31 of the participant in question.

According to the game of the present invention, points are awarded to each of the participants in each Australian Football League match for the completion of predefined activities during the match. In this example, points are awarded to each participant notably for possessions, goals and tackles whilst points are deducted notably for penalties and missed shots at goal. The number of points awarded to each participant for the completion of each of the predetermined activities varies depending upon the category of each participant, as follows:

Backmen

A backman receives 1 game point for each kick and handball and 3 game points for a mark, but as the defensive aspect of his game is most important, he also receives 2 game points for a tackle. A backman loses 2 game points for giving away a free kick.

| | |
|---|---|
| Mark | 3 game points |
| Kick | 1 game point |
| Handball | 1 game point |
| Tackle | 2 game points |
| Free Against | Minus 2 game points |

Forwards

A forward receives 1 game point for each kick and handball as well as 3 game points for taking a mark. He receives 6 game points for each goal he kicks, as this is a forward's main objective. A forward is not penalised for giving away a free kick, but does lose 2 game points for each behind he kicks. The reason behind this nuance in the scoring system is that free kicks given away near your own goal are not as damaging to a team as a wasted opportunity in front of goal.

| | |
|---|---|
| Mark | 3 game points |
| Kick | 1 game point |
| Handball | 1 game point |
| Goal | 6 game points |
| Behind | Minus 2 game points |

Midfielders

Midfielders receive 2 game points for each kick and handball but only 1 game point for each mark. The reason for this is that midfielders generally take uncontested marks. As such, the awarding of more than 1 game point for a mark would not be justified. As goalkicking is not a midfielder's primary objective but is nevertheless important, 3 game points are awarded for each goal. 2 game points are deducted each time a midfielder gives away a free kick.

| | |
|---|---|
| Mark | 1 game point |
| Kick | 2 game points |
| Handball | 2 game points |
| Goal | 3 game points |
| Free Against | Minus 2 game points |

Ruckmen

A ruckman receives 3 game points for each mark taken and 3 game points for each goal scored. He also gets 1 game point for each kick and handball. As his ruckwork is his reason for being selected, he also receives 1 game point for each hitout. He loses 2 game points for each free given away.

| | |
|---|---|
| Mark | 3 game point |
| Kick | 1 game points |
| Handball | 1 game points |
| Hitout | 1 game point |
| Goal | 3 game points |
| Free Against | Minus 2 game points |

In the present example, game players effectively challenge each other prior to each round of Australian Football League matches during the annual Australian Football League competition by selecting one or more participants in that round of matches. Selection of participants is based upon the predicted behaviour of the participants according to the above mentioned game points system. Each selection made by a game player may correspond to a game card in the possession of the game player.

Game cards are made available to those members of the general public wishing to be game players. In one embodiment, game cards may be sold in both a “starter deck” format as well as in “booster packs”. A starter deck generally ensures that all players have enough cards to play the game according to the invention. The starter deck includes 36 game cards, 35 of which are randomly selected from a full set of game cards.

Each of the one hundred participants may appear on more than one different card. In one example, each of these participants appears on six different cards, five of which bear information 32 to 35 identifying one or more of the rounds of the Australian Football League competition. In addition, each participant may appear on one or more wild card game cards. In the present example, 1 wildcard appears in each starter deck.

Once a game player has purchased a starter deck of game cards, they can increase their chance of success in the game by purchasing booster packs. Booster packs in this example contain eight randomly selected game cards. Wild card game cards may be placed at random in the booster packs.

In one variant of the game, the participants selected by any game player must correspond not only to a game card of that participant in possession of that player, but to a game card associated with that participant which additionally indicates the particular weekly round the Australian Football League competition in which participant is next to compete. In this variant, a wild card game card representing a particular participant may be used to select that participant irrespective of the round of matches in question.

One embodiment of the manner in which game players select participants in advance of the performance of each round of matches, and by which one or more winning game players are determined, will now be described with reference to FIGS. 6 to 9. FIG. 6 is a representative flow chart which provides a system overview of the program stored in the memory device 10 of the central controller 2. This program operates in conjunction with a web browser installed at each of the remote terminals 3 and 4. When a game player accesses the central controller 2 by means of one or other of the remote terminals 3 or 4, that player is presented with a main menu 40. From this menu, the player is able to register, via a registration screen 41, to play the game. In addition, a player may be able to access a shopping menu to purchase various merchandising products, or provide feedback to the game organisers via a feedback menu 43. Once game players have registered, a login screen 44 will be presented, enabling them to make their participant selections for one or more upcoming Australian Football League rounds of matches, at a participant selection screen 45. A message board screen 46 may also be accessed from the logon screen 44, to enable game players to read announcements of game winners from previous rounds of the Australian Football League competition.

One example of the participant selection screen 45 is shown in FIG. 9. The participant selection screen 45 displays a representation 146 of an Australian football sporting field, over which are displayed groups of drop down windows 47 to 51 enabling the selection by each game player from the one hundred selected participants in the Australian Football League competition, of a predetermined number of participants, by category, that the game player predicts will perform well (according to the above described points system) in that round of Australian Football League competition. Accordingly, the group of drop down windows 47 enables the selection of six forwards, the group of drop down windows 48 enables the selection of three midfielders, the group of drop down windows 49 enables the selection of six backmen, the group of drop down windows 50 enables the selection of one ruckman and two midfielders, whilst the group of drop down windows 51 enables the selection of an inter-change forward, midfielder, backman and ruckman.

To facilitate the selection of participants by each game player, each of the game cards illustrated in FIG. 2 to FIG. 5 may include information indicating that player's historical performance in the Australian Football League competition. For example, a participant's average score historically for the previously season 52 per match, the teams against which he has previously performed high game points 53, and the teams against which he has previously performed lower game points 54, may be indicated. The game cards illustrated in FIGS. 2 to 5 also include an indication of that participants overall category ranking within the one hundred selected participants 55, and an indication of the number of occasions on which that participant has actually participated in a match over a pre-determined period 56 (participation may not occur if a participant is not selected or is injured for the weekly match).

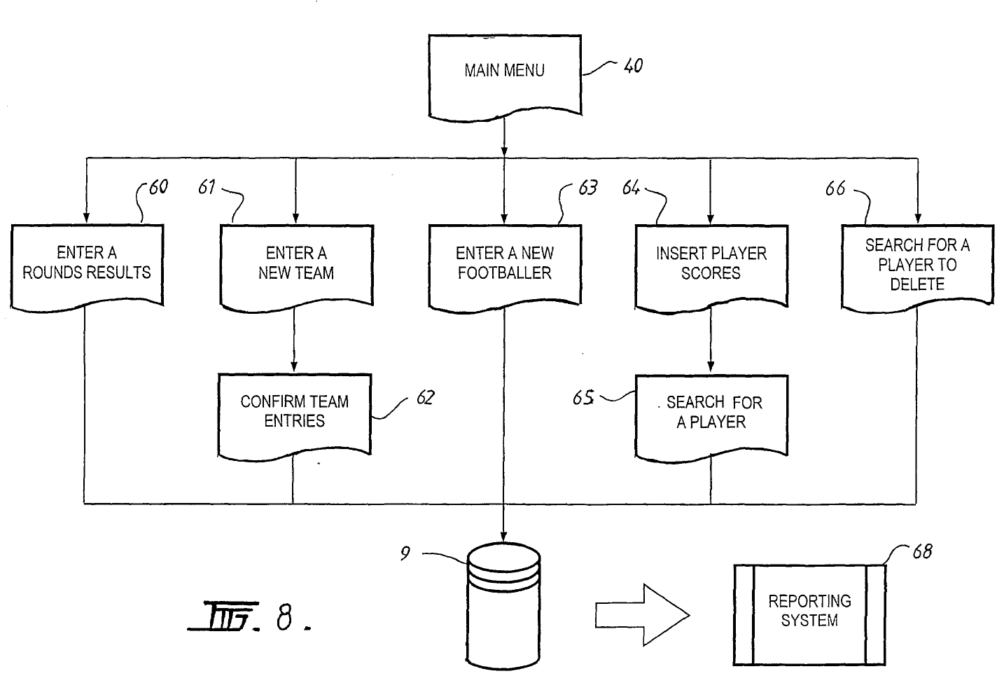

As seen in FIG. 7, once a game player has made his participant selections in advance of the performance of each round of Australian Football League matches at steps 152 or 153, and validated those choices at steps 155 and 156, participant selection information indicative of the participants selected by each game player is stored in the memory device 9 within the central controller 2. Confirmation of the recordal of the players participant selection information is displayed to the player at step 157, and the player presented with the options of printing a list of the participants selected for that round or requesting an email confirmation of his selections at step 159.

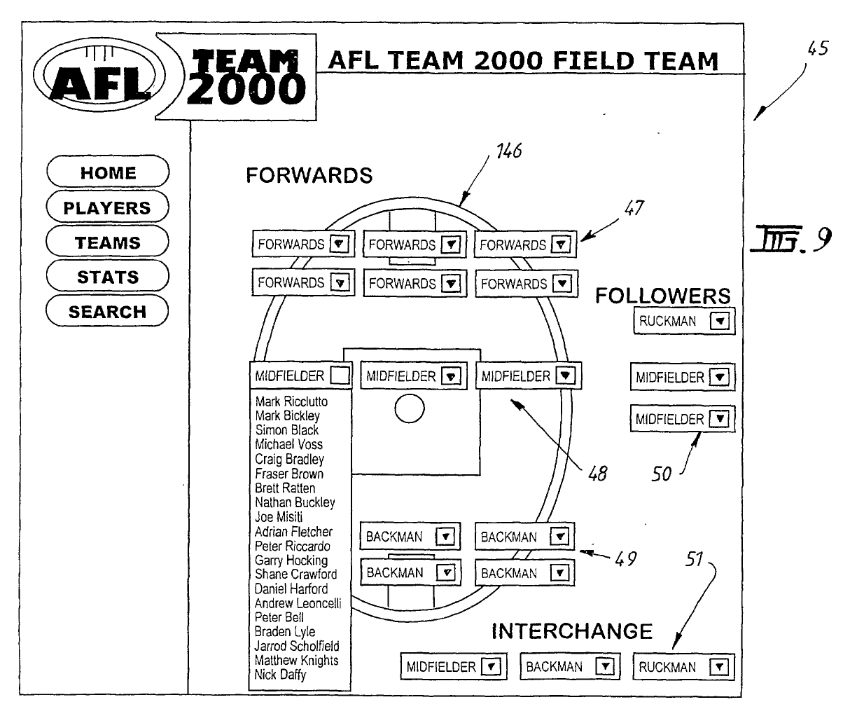

Once the round of Australian Football League matches has been completed and the actual performance of each participant determined, based upon the number of kicks, marks, tackles, etc completed by each of the one hundred selected participants who participated during that round of competition, a system administrator stores the results for that round in the central controller 2 as indicated in FIG. 8. The system administrator enters the results by accessing the main menu 40, and, at step 60, entering the number of game points awarded to each participant for the completion of the above mentioned predetermined activities. These results are then stored in the memory device 9 of the central controller 2.

The program stored in the memory device 10 of the system controller 2 may also enable the system administrator, via the main menu 40, to enter and confirm new teams participating in the competition (steps 61 and 62), enter details of a new participant in the competition (step 63), enter game point scores for individual participants in the competition (step 64) and to search for previously entered participants (step 65), as well as deleting previously entered participants (step 66). Once details of a completed round have been entered in the database 9, the program stored in the memory device 10 of the central controller 2 assesses the actual behaviour of each participant during the actual performance of the round of Australian Football League matches, at step 67 illustrated in FIG. 6, against the stored participant selection information of each game player. The program stored in the memory device 10 of the central controller 2 determines one or more winning game players from the total number of game points awarded to those participants previously selected by each game player during the now completed round of Australian Football League matches.

The program stored in the memory device 10 of the central controller 2 may also include a reporting system 68 for advising winning game players of their success in that round of matches. The reporting may take place by means of conventional mail, email modification or notification by a web browser display at one of the remote terminals 3 or 4.

In order to confirm that participant selection by each game player were limited to those participants corresponding to game cards in the possession of each player, the game according to the invention may further comprise means for verifying the possession by each winning player of game cards indicative of the participants selected by that winning player. Accordingly, each winning player may be required forward the game cards upon which their selections were based to the game organisers, in order to reclaim any prizes offered to game winners. Prizes may include either promotional items or services, or monetary rewards. It will be appreciated that various other means may be provided for verifying the possession of game cards by winning players. For example, each game card produced may have identified therewith a unique alpha numeric code which is required to be entered by each game player, together with the name of the selected participant. The program stored in the memory device 10 may act to verify that each such alpha numeric code appears only once in the participant selection information stored in the memory device 9 in order to prevent fraudulent selection of participants.

It is to be appreciated that modifications and/or alterations may be made to the game and method of playing a game without departing from the ambit of the present invention described herein. Whilst the present invention has been described in relation to a football competition including one or more rounds of one or more events, it will be appreciated that the invention is applicable to a number of other competitions, such as basketball, baseball, soccer or even athletic competitions composed of teams representing one or more countries which compete in one or more events. It will also be understood that the invention has application in one or more events which are not necessarily sporting in nature, but which are nevertheless based upon the predicted behaviour of participants in each event. For example, game players may be required to predict the behaviour of one or more characters participating in one or more episodes of a television or like program.

Another variant of the game according to the present invention will now be described in relation to basketball. In this example, 100 leading participants in the National Basketball Association (NBA) or other competition are selected by the game organisers, and one or more game cards within each set of game cards are printed with appropriate indicia or otherwise marked so as to be representative of each of these 100 selected participants. An example of this type of game card is shown in FIG. 10. As can be seen from this Figure, the game card 100 includes the name 101 and image 102 of each participant. Each of the game cards also includes the nominal category 103 (centre, guard or forward) of the participant in question. Of the 100 leading participants selected by the game organisers, there may be 20 centres, 40 guards and 40 forwards. Each of the NBA franchises may be represented with the minimum of two players and a maximum of five players. In one embodiment, there are five cards for each of the 100 featured NBA participants, consisting of two common cards, one bronze all-star card, one silver all-star card and one gold all-star card for each participant. In another embodiment, there are three cards for each of the 100 featured NBA participants, consisting of one bronze all-star card, one silver all-star card and one gold all-star card for each participant.

Points are awarded to each of the participants in each NBA match for the completion of predefined activities during the match. In this example points are awarded to each participant for points scored, rebounds, offensive rebounds, assists, steals and blocks. Points are deducted for turnovers, personal fouls, missed free throws and fouling out. The number of points awarded to or deducted from each participant may vary depending upon the category of each participant, as follows:

Centres

Points—1 game point

Defensive Rebounds—2.5 game point

Offensive rebounds—3 game points

Assists—1 game points

Steals—1.5 game points

Blocks—3 game points

Turnovers—−2 game points

Personal foul—−2 game point

Forwards

Points—1 game point

Defensive Rebounds—2 game point

Offensive rebounds—2.5 game points

Assists—1.5 game points

Steals—2 game points

Blocks—2.5 game points

Turnovers—−2 game points

Personal foul—−2 game point

Guards

Points—1 game point

Defensive Rebounds—1 game point

Offensive rebounds—1 game points

Assists—3 game points

Steals—2.5 game points

Blocks—1 game points

Turnovers—−2 game points

Personal fouls—−2 game point

In this example, game players effectively challenge each other prior to each round of the NBA competition by selecting one or more participants in that round of matches. Selection of participants is based upon the predicted behaviour of the participants according to the above-mentioned game points system. Each selection made by a game player may correspond to a game card in the possession of the game players. To facilitate the selection of participants by each game player, each of the game cards may indicated information indicating that participants historical performance in the NBA competition. For example, the game card 100 may include a ranking field 104 based on the previous year's statistics of that participant and enabling that participant to be given a ranking comparative to all other participants in the NBA competition. An average score field 105 on the game card 100 indicates the average number of points scored by each participant from the previous NBA season. A play rate field 106 showing how many games a participant has played in, or how the average court time (minutes played in a match), from the previous season. A strengths field 107 and a weaknesses field 108 may also be represented on the game card 101 to show the three teams against which the participant has scored highest and lowest against in the previous season.

The game card 100 may also include a card category field 109 indicating whether the card is a common card, bronze all-star card, silver all-star card or gold all-star card. Points awarded to a game player based upon the performance of a participant for which the game player possess a bronze all-star card are multiplied by 1.5 times. Similarly, a silver all-star card enables points earned by a participant to be multiplied by 2, whereas a gold all-star card enables points earned by a participant to be multiplied by 3.

Prior to a particular round of the NBA competition, games players select from amongst the cards in their possession, a selection of five best players consisting of one centre, two guards, and two forwards. A maximum of one bronze all-star card, one silver all-star card and one gold all-star card per team may be a limitation placed on the game by a game organiser. Entry of player selection and determination of prizes is performed by the Internet, in a manner similar to that described in the previously described embodiment of the invention.

In an alternate version, game players choose a starting five participants and an additional five participants to play on the bench. Those participants chosen to play on the bench may receive a reduced number of game points for the predetermined events performed during each NBA game.

Similar games to that described in relation to FIG. 10 may be played in respect of baseball and soccer. For example, in baseball, participant categories of pitcher, catcher, short stop, first base man, second base man, third base man and outfielders may be selected. Points may be awarded for hits, home runs, etc, while points may be deducted for strike outs or errors.

With respect to soccer, participant categories of goalkeeper, defender, midfielder, attacking midfielder and striker may be selected. Points may be awarded passes to own players, goal assists, goals, etc, while points may be deducted for passes to opposition players and other errors.

Moreover, in a further variant of the game according to the present invention, a game organiser may select a plurality of selected participants in each event in advance of the performance of that event, the actual behaviour of each of the selected participants then being assessed during the actual performance of the event to determine one or more winning participants. One or more game winning players may subsequently be determined by possession of a game card corresponding to the one or more winning participants.

For example, a television station or other game organiser may nominate one of its televised football matches as an event in conjunction with which the game according to the present invention is to be played. At the beginning of the televised game, a commentator may indicate to viewers which of the participants in the match are the selected participants. A visual representation of game cards corresponding to the selected participants may then be displayed on the screen to viewers.

A commentator may explain to viewers that they are in the running to win prizes if they possess a game card corresponding to any one or more selected players in the match. At certain stages during the game, the commentator may provide updates as to the progress of each of the participants in a match, based upon the number of game points scored according to the above described criteria. At the end of the match, the participant who has scored the most points is announced. Viewers who have in their possession a game card corresponding to that participant are then invited to send in that game card in order to receive a prize.

In further variants of the invention, registration of each of the game players may be required. Registration may be effected, for example, by means of communication between a remote terminal and a central controller as described in relation to FIG. 1. Payment may also be required from each game player. During registration, a game player may be required to authorise the debiting of his credit card with an amount corresponding to a game entry fee. Skilled persons in the art will easily envisage similar payment mechanisms.

1. A game for a plurality of game players, in conjunction with the competition having one or more events whose outcomes are unknown prior their performance, wherein a plurality of participants take part in each event, the game comprising:
one or more sets of game cards, each card being representative of a participant in said one or more events;
selection means for selection by each player of one or more participants in each event in advance of the performance of each event, participant selection being based upon the predicted performance by the participants during each event, each selected participant corresponding to a game card in possession of that player;
storage means for centrally storing participant selection information indicative of the one or more participants selected by each player, and assessment means for assessing the actual performance of each participant during the actual performance of the event against stored participant selection information of each player to thereby determine one or more winning players.

2. A game according to claim 1, wherein each event is a sporting contest, the competition including a series of one or more of such sporting contests.

3. A game according to claim 2, wherein each sporting contest is played between two or more teams of a plurality of participants.

4. A game according to any one of the preceding claims, wherein the performance of each participant during the event corresponds to the completion by each participant of predefined activities during that event.

5. A game according to claim 4, wherein each of the participants is awarded a predetermined number of points for the completion of each of the predetermined activities.

6. A game according to claim 5, wherein the assessment means acts to assess the performance of each participant by total number of points awarded to that participant during each event.

7. A game according to any one of the preceding claims, wherein each of the participants is categorised according to one of a plurality of categories, the participant selection information being indicative of one or more participants from each of the plurality of categories.

8. A game according to claim 7, wherein each of the plurality of categories corresponds to a role played by one or more of the participants during each event.

9. A game according to claim 8, wherein players of the game selects one or more participants from each of the plurality of categories prior to the performance of each event.

10. A game according to any one of the preceding claims, wherein each participant is eligible to participate in a plurality of events during the competition.

11. A game according to claim 10, wherein the competition comprises a plurality of rounds in which a team of participants compete against other teams in the competition.

12. A game according to claim 11, wherein each of the game cards bears information identifying one or more of the plurality of events.

13. A game according to claim 12, wherein the set of game cards includes the plurality of game cards indicative of each participant, each game card bearing information identifying different ones of the plurality of events.

14. A game according to claim 13, wherein participant selection before each event is based upon possession by a player of a game card indicative of a participant for that event.

15. A game according to any one of the preceding claims, and further comprising:
verification means for verifying the position by each winning player of game cards indicative of participant selected by that winning player.

16. A game according to claim 15, wherein the verification means further acts to verify that each game card upon which participants are selected corresponds to a particular event.

17. A method of playing a game, by a plurality of players, in conjunction with a competition having one or more events whose outcomes are unknown prior to their performance, wherein a plurality of participants take part in each event and the game includes a plurality of game cards, each card being indicative of a participant in said one or more events, the method comprising the steps of:
selecting by each player of one or more participants in each event in advance of the performance of each event, participant selection being based upon the predicted performance by the participants during each event, each selected participant corresponding to a game card in possession of that player, centrally storing participant selection information indicative of the one or more participants selected by each player, and
assessing the actual performance of each participant during the actual performance of the event against the stored participant selection information of each player to thereby determine one or more winning players.

18. A game for a plurality of players, in conjunction with the competition having one or more events whose outcomes are unknown prior to their performance, wherein a plurality of participants take part in each event, the game comprising:
one or more sets of game cards each indicative of a participant in said one or more events,
a central controller including a processing means and a memory means operatively connected to the processing means, the memory means containing a program, adapted to be executed by the processing means, for
(iv). selection by each player of one or more participants in each event in advance of the performance of each event, participant selection being based upon the predicted performance by the participants during each event, each selected participant corresponding to a game card in possession of that player,
(v). centrally storing participant selection information indicative of the one or more participants selected by each player, and
(vi). assessing the actual performance of each participant during the actual performance of the event against the stored participant selection information of each player to thereby determine one or more winning players, and
at least one remote terminal, adapted for communication with the central controller, for transmitting the participant selection information to the central controller.

19. A game for a plurality of players, in conjunction with the competition having one or more events whose outcomes are unknown prior their performance, wherein a plurality of participants take part in each event, the game comprising:
one or more sets of game cards, each card being representative of a participant in said one or more events;
selection means for selection by a game organiser of a plurality of selected participants in each event in advance of the performance of each event, assessment means for assessing the actual performance of each of said selected participants during the actual performance of the event to thereby determine one or more winning participants, and one or more game winning players being subsequently determined by possession of a game card corresponding to said one or more winning participants.

20. A method of playing a game, by a plurality of players, in conjunction with a competition having one or more events whose outcomes are unknown prior to their performance, wherein a plurality of participants take part in each event and the game includes a plurality of game cards, each card being indicative of a participant in said one or more events, the method comprising the steps of:
selecting by a game organiser of a plurality of selected participants in each event in advance of the performance of each event, and
assessing the actual performance of each of said selected participants during the actual performance of the event to thereby determine one or more winning participants, one or more game winning players being subsequently determined by possession of a game card corresponding to said one or more winning participants.
